(19) United States
(12) Patent Application Publication
(10) Pub. No.: US 2019/0329389 A1
(43) Pub. Date: Oct. 31, 2019

(54) METHOD AND APPARATUS FOR REMOVAL OF TILE LEVELING CLIPS

(71) Applicants: Byron Babb, Evansville, IN (US); Brent Bagby, Evansville, IN (US)

(72) Inventors: Byron Babb, Evansville, IN (US); Brent Bagby, Evansville, IN (US)

(21) Appl. No.: 16/393,423

(22) Filed: Apr. 24, 2019

Related U.S. Application Data
(60) Provisional application No. 62/664,337, filed on Apr. 30, 2018.

(51) Int. Cl. B25B 27/00; E04F 21/00

(52) U.S. Cl. CPC B25B 27/0092; E04F 21/0092

(57) ABSTRACT

A method and apparatus for removal of tile leveling clips from a newly laid tile floor is provided. Each tile leveling clip has a base member embedded in thin-set mortar and a vertical planar member extending upwardly from a center region of the base member in a gap between adjacent tiles on a surface. The apparatus includes a clip engaging member formed from a strong, rigid material and having a substantially planar leading member. A roller having a diameter is provided and is positioned in the clip engaging member such that the outer surface of the roller extends a distance beyond a lower edge of the leading member that is less than the distance the vertical planar member of the tile leveling clip extends above the adjacent tiles. An elongated handle is provided having a first end affixed to the clip engaging member and a second end configured for gripping by a user. The user pushes on the handle causing the roller to roll across the floor and the leading member to engage the vertical planar member of the tile leveling clip until it separates from the base member.

### BACKGROUND OF THE INVENTION

### Field of the Invention

The present invention relates to a method and apparatus for use in connection with the installation of tile flooring systems. More specifically, the present invention relates to a method and apparatus for quickly and easily removing the tile leveling clips that must be removed from in between tiles before grouting.

### Description of the Related Art

Tile flooring is a popular option in both residential and commercial buildings. The process for installing a tile flooring system involves first ensuring a substantially level and stable base upon which the tiles are to be laid. A layer of thin-set mortar is then spread on the surface to which the tile is to be applied. The tiles are then laid over the layer of thin-set mortar. Once the thin-set mortar dries or cures, the tiles are permanently affixed to the surface.

In order to ensure that the final tiled surface is level, tile leveling clips 10 and wedges 20 as shown in FIG. 1 can be used. The tile clip includes a base member 12 that is embedded in the thin-set mortar 30 and has a pair of opposing wings, each of which extend under adjacent tiles. A vertical planar member 14 extends upwardly from the center region of the base 12 in the gap between adjacent tiles. The vertical planar member 14 has an opening therein that is sized to receive the wedge 20. The bottom surface of the wedge extends a distance from the edge of each adjacent tile while the upper sloped surface 24 of the wedge 20 engages the upper edge of the opening. The camming action between the upper sloped surface of the wedge 20 and the upper edge of the opening 16 presses the lower surface of the wedge 20 into engagement with the tiles thereby having a leveling effect on the adjacent tiles it engages.

Once the thin-set mortar has cured, the wedges 20 and clips 10 must be removed before grouting. At present, the wedges and clips are commonly removed by the user kicking at each wedge/clip assembly. This process is time consuming, unreliable and difficult.

Accordingly, there is a need for a method and apparatus for quickly and easily removing the tile leveling clips and wedges that remain after a tile floor has been laid.

### SUMMARY OF THE INVENTION

It is therefore an object of the present invention to provide an apparatus for quickly and easily removing leveling clips from a newly installed tile floor.

It is also an object of the invention to provide a method for quickly and easily removing leveling clips from a newly installed tile floor prior to grouting.

The present invention meets these objects by providing a leveling tile removal tool having an elongated handle that engages a square tube at a lower end thereof with a roller housed therein. In operation, the user causes the roller to roll across the newly installed floor and the leading edge of the square tube strikes the vertical planar member of the leveling clip causing it to snap off at a pre-weakened point below the floor surface.

According to one aspect of the present invention, there is provided an apparatus for removal of tile leveling clips. Each of the tile leveling clips includes a base member embedded in thin-set mortar and a vertical planar member extending upwardly from a center region of the base member in a gap between adjacent tiles on a surface. The apparatus includes a clip engaging member formed from a strong, rigid material and having a substantially planar leading member, a first side member extending in a first direction substantially perpendicularly from a first end of the leading member and a second side member extending in said first direction substantially perpendicularly from a second end of the leading member. The apparatus further includes a roller having an axle with a first end rotatably engaging the first side member and a second end rotatably engaging the second side member. The roller has a diameter and is positioned in the first and second side members such the outer surface of the roller extends a distance beyond a lower edge of the leading member that is less than the distance the vertical planar member of the tile leveling clip extends above the adjacent tiles. An elongated handle is provided having a first end affixed to the clip engaging member and a second end configured for gripping by a user.

The clip engaging member may further include a substantially planar trailing member having a first end engaging a free end of the first side member and a second end engaging a free end of the second side member. The first end of the elongated handle may be affixed to the trailing member of the clip engaging member. The roller may include a cylindrical outer member formed from a semi-rigid material and an axle formed of a rigid material passing through a central opening in the cylindrical outer member. The cylindrical outer member of the roller may be formed from urethane. Each end of the axle may include a threaded opening and each of the first and second side members may include an opening. First and second bolt members may be provided passing through the first and second opening in the first and second side members, respectively, and threadabtly engaging the threaded openings in the first and second ends of the axle, respectively. According to one aspect of the invention, the clip engaging member is formed from steel.

A further aspect of the invention is a method for removing tile leveling clips from a newly laid tile floor. First, a roller of an apparatus for removal of tile leveling clips is placed into engagement with a surface of a newly laid tile floor. The newly laid tile floor includes a plurality of tile leveling clips, each having a base member embedded in thin-set mortar and a vertical planar member extending upwardly from a center region of the base member in a gap between adjacent tiles on a surface. A user grips a second end of an elongated handle that has its first end affixed to a clip engaging member. The clip engaging member includes a leading member having a lower edge wherein the distance between the lower edge and the surface of the tile floor is less than the distance between the tile floor and an upper end of the vertical planar member of the tile clip when the roller is placed into engagement with the floor. The clip engaging member in moved in a horizontal direction substantially parallel to the floor by applying force to the handle proximate the second end thereof and causing the roller to rotate about its axis and roll across the floor. This causes the lower edge of the leading member of the clip engaging member to forcefully engage an upper region of the vertical planar member of the tile leveling clip thereby causing the vertical member to separate from the base member of the tile leveling clip.

These and other objects, features and advantages of the present invention will become apparent from a review of the following drawings and detailed description of the preferred embodiments of the invention.

### BRIEF DESCRIPTION OF THE DRAWINGS

The present invention can best be understood in connection with the accompanying drawings. It is noted that the invention is not limited to the precise embodiments shown in the drawings, in which:

FIG. 1 is perspective view of the use of tile leveling clips and wedges as is known in the prior art.

FIG. 2 is a side plan view of an apparatus for removal of tile leveling clips according to a preferred embodiment of the invention.

FIG. 3A is a top plan view of the square tube of the apparatus for removal of tile leveling clips shown in FIG. 2.

FIG. 3B is a side plan view of the square tube shown in FIG. 3A of the apparatus for removal of tile leveling clips shown in FIG. 2.

FIG. 4A is an end plan view of the roller of the apparatus for removal of tile leveling clips shown in FIG. 2.

FIG. 4B is a side plan view of the roller shown in FIG. 4A of the apparatus for removal of tile leveling clips shown in FIG. 2.

FIG. 5A is an end plan view of the the axle of the apparatus for removal of tile leveling clips shown in FIG. 2.

FIG. 5B is a side plan view of the axle shown in FIG. 5A of the apparatus for removal of tile leveling clips shown in FIG. 2.

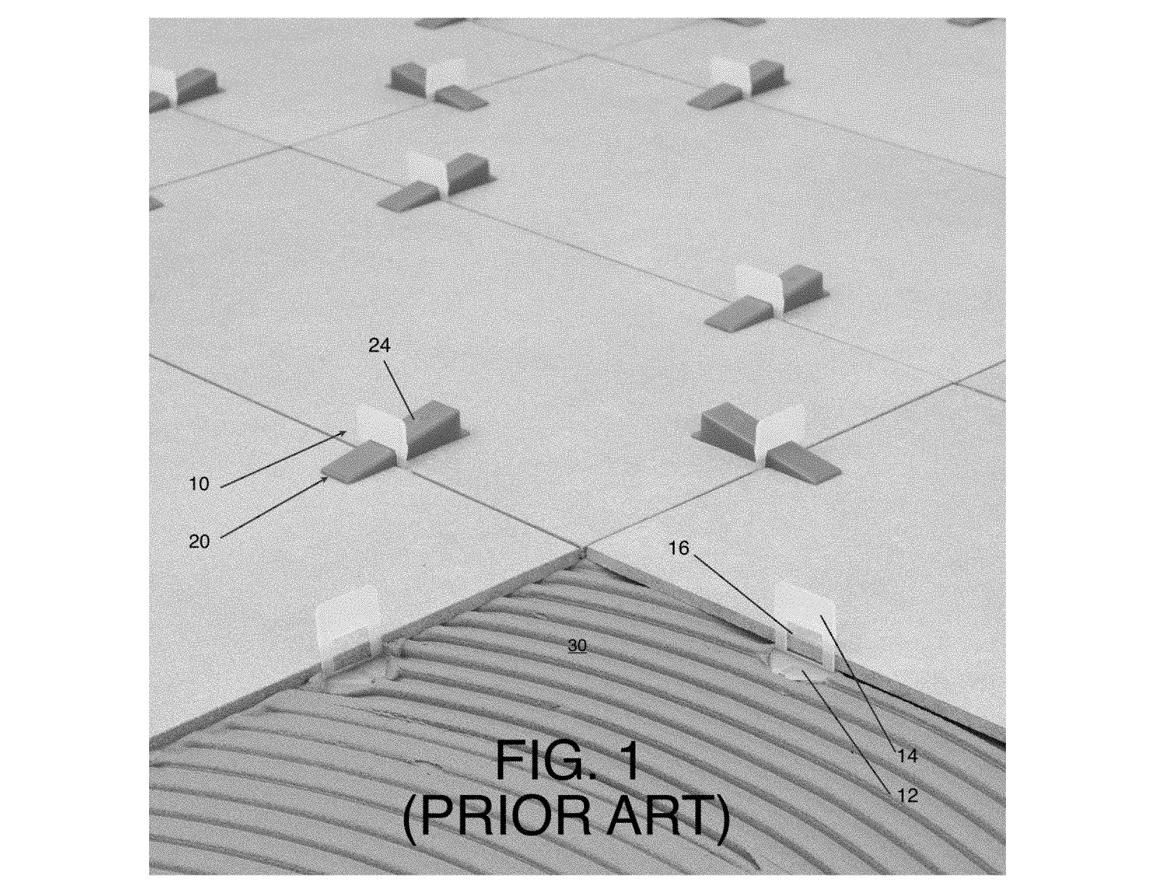

### DETAILED DESCRIPTION OF THE INVENTION

For purposes of promoting and understanding of the principles of the invention, reference will now be made to the embodiments illustrated in the drawings and specific language will be used to describe the same. It will nevertheless be understood that no limitation of the scope of the invention is thereby intended. The invention includes any alterations and further modifications in the illustrated devices and described methods and further applications of the principles of the invention that would normally occur to one skilled in the art to which the invention relates.

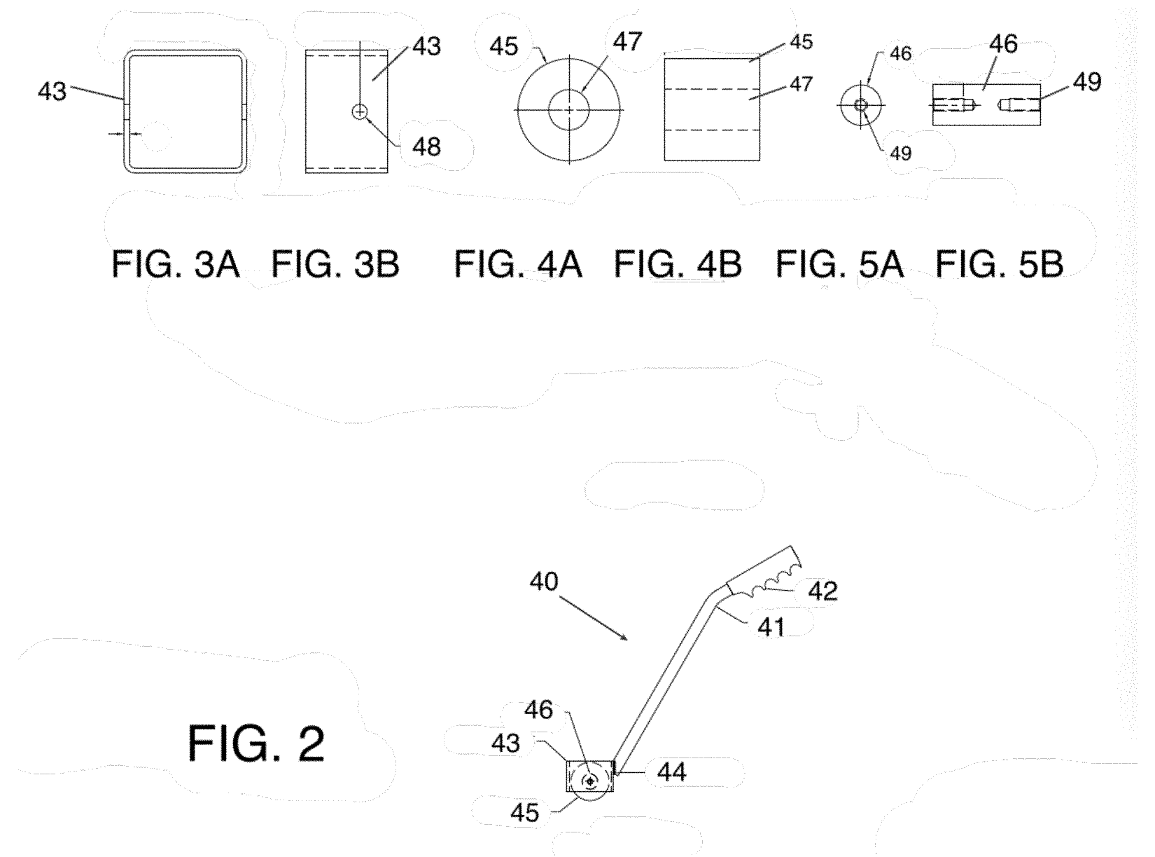

As best shown in FIG. 2, one presently preferred embodiment of the invention comprises an apparatus 40 for removal of tile leveling clips comprising an elongated handle 41 having a grip 42 at a first free end and being affixed to a square tube 43 at a second end, preferably by a weld 44 or other suitable means of affixing the square tube 43 to the lower end of the handle 41. The handle 41 may be formed of any suitable rigid strong material, and is preferably formed of hot rolled steel with a diameter of approximately ¾″. The grip 42 is formed from dip molded plastic of vinyl. A roller 45 is disposed within the square tube 43 and has an axle 46 passing through a central opening 47 therein which permits rotation of the roller 45. The roller 45 is preferably formed from a semi-rigid material such as urethane. The square tube 43 includes opposing holes 48 in the sidewalls thereof to received a pin or bolt that passes through the opening 48 and threadably engages the corresponding threaded opening 49 in the axle 45. The square tube is formed from a strong, rigid material, preferably steel.

In operation, the user grips the tile leveling clip removal apparatus 40 at the grip 42. The roller 45 engages the newly laid tile surface. The user pushes the apparatus 40 back and forth across the floor such that the leading edge of the square tube 43 comes into contact with the vertical planar member 14 of the leveling clip 10 that extends above the surface of the newly laid floor. The force of the leading edge of the square tube as it comes into contact with the vertical planar member 14 causes the vertical planar member to snap off from the base member 12 at a pre-weakened location below the surface of the newly laid floor. The square tube 43, and roller 45 are sized such that the roller elevates the square tube 43 a distance above the floor that is less than the height of the vertical planar member 14 so that the leading edge of the square tube strikes the vertical planar member 14 causing it to snap off from the base member 12. Given the dimensions of leveling clips currently in use, the square tube measures 3 inches by 3 inches, with the hole 48 for the axle located 11/16″ from the lower edge of the square tube 43. The roller 45 is preferably 2½ inches in diameter and 2 5/16 inches wide.

This detailed description, and particularly the specific details of the exemplary embodiment disclosed, is given primarily for clearness of understanding and no unnecessary limitations are to be understood therefrom, for modifications will become evident to those skilled in the art upon reading this disclosure and may be made without departing from the spirit or scope of the claimed invention.

I claim:

1. An apparatus for removal of tile leveling clips, each of said tile leveling clips having a base member embedded in thin-set mortar and a vertical planar member extending upwardly from a center region of the base member in a gap between adjacent tiles on a surface, said apparatus comprising:
a clip engaging member formed from a strong, rigid material and having a substantially planar leading member, a first side member extending in a first direction substantially perpendicularly from a first end of the leading member and a second side member extending in said first direction substantially perpendicularly from a second end of the leading member;
a roller having an axle with a first end rotatably engaging said first side member and a second end rotatably engaging said second side member, said roller having a diameter and being positioned in said first and second side members such the outer surface of the roller extends a distance beyond a lower edge of the leading member that is less than the distance said vertical planar member of the tile leveling clip extends above said adjacent tiles; and
an elongated handle having a first end affixed to said clip engaging member and a second end configured for gripping by a user.

2. The apparatus for removal of tile leveling clips according to claim 1 wherein said clip engaging member further includes a substantially planar trailing member having a first end engaging a free end of the first side member and a second end engaging a free end of the second side member.

3. The apparatus for removal of tile leveling clips according to claim 2 wherein the first end of the elongated handle is affixed to said trailing member of said clip engaging member.

4. The apparatus for removal of tile leveling clips according to claim 1 wherein said roller comprises a cylindrical outer member formed from a semi-rigid material and an axle formed of a rigid material passing through a central opening in the cylindrical outer member.

5. The apparatus for removal of tile leveling clips according to claim 4 wherein said cylindrical outer member of the roller is formed from urethane.

6. The apparatus for removal of tile leveling clips according to claim 4 wherein each end of said axle includes a threaded opening and each of said first and second side members includes an opening, and further comprising first and second bolt members passing through said first and second opening in said first and second side members, respectively, and threadabtly engaging said threaded openings in said first and second ends of said axle, respectively.

7. The apparatus for removal of tile leveling clips according to claim 1 wherein said clip engaging member is formed from steel.

8. A method for removing tile leveling clips from a newly laid tile floor comprising the steps of:
a. placing a roller of an apparatus for removal of tile leveling clips into engagement with a surface of a newly laid tile floor, said newly laid tile floor including a plurality of tile leveling clips, each having a base member embedded in thin-set mortar and a vertical planar member extending upwardly from a center region of the base member in a gap between adjacent tiles on a surface;
b. gripping a second end of an elongated handle, said first end of said elongated handle being affixed to a clip engaging member, said clip engaging member having a leading member having a lower edge wherein the distance between the lower edge and the surface of the tile floor is less than the distance between the tile floor and an upper end of the vertical planar member of the tile clip when said roller is placed into engagement with the floor;
c. moving the clip engaging member in a horizontal direction substantially parallel to the floor by applying force to the handle proximate the second end thereof and causing the roller to rotate about its axis and roll across the floor, and
d. causing the lower edge of the leading member of the clip engaging member to forcefully engage an upper region of the vertical planar member of the tile leveling clip thereby causing said vertical member to separate from the base member of the tile leveling clip.

9. The method for removing tile leveling clips according to claim 8 further comprising repeating steps c and d for each tile leveling clip in the newly laid floor.
